(19) United States
(12) Patent Application Publication
(10) Pub. No.: US 2020/0045517 A1
(43) Pub. Date: Feb. 6, 2020

(54) METHOD AND DEVICE FOR PROCESSING VEHICLE TO EVERYTHING (V2X) MESSAGE

(71) Applicant: LG Electronics Inc., Seoul (KR)

(72) Inventor: Yongsoo PARK, Seoul (KR)

(21) Appl. No.: 16/595,944

(22) Filed: Oct. 8, 2019

(30) Foreign Application Priority Data
Sep. 5, 2019 (KR) 10-2019-0110192

(51) Int. Cl. H04W 4/40; H04W 4/12; H04W 4/029; H04W 4/20; H04W 72/04

(52) U.S. Cl. CPC H04W 4/40; H04W 4/12; H04W 72/0406; H04W 4/20; H04W 4/029

(57) ABSTRACT

Provided is a method and device for identifying information included in a first V2X message and generating a second V2X message based on the first V2X message and information acquired through a sensor. At least one of a vehicle, a device, and an autonomous vehicle of the present disclosure may be associated with an artificial intelligence (AI) module, an unmanned aerial vehicle (UAV), a robot, an augmented reality (AR) device, a virtual reality (VR) device, and a device related to a 5G service, for example.

### CROSS-REFERENCE TO RELATED APPLICATION

This application claims the benefit of Korean Patent Application No. 10-2019-0110192, filed on Sep. 5, 2019, the disclosure of which is incorporated herein in its entirety by reference.

### BACKGROUND

### 1. Field

The present disclosure relates to a method and device for processing a vehicle to everything (V2X) message and, more particularly, to a method and device for correcting a transmitted V2X message and retransmitting the corrected V2X message.

### 2. Description of the Related Art

As communication technologies between vehicles, servers, infrastructures, and user terminals, interest in vehicle to everything (V2X) communication has been increasing. Accordingly, there is a desire for a method to effectively provide the V2X communication.

An autonomous vehicle refers to a vehicle equipped with an autonomous driving device that recognizes an environment around the vehicle and a state of the vehicle to control driving of the vehicle based on the environment and the state. With progresses in research on autonomous vehicles, studies on various services that may increase a user's convenience using the autonomous vehicle are also in progress.

### SUMMARY

An aspect provides a method and device for processing a vehicle to everything (V2X) message. Technical goals to be achieved through the example embodiments are not limited to the technical goals as described above, and other technical tasks can be inferred from the following example embodiments.

According to an aspect, there is provided a method of processing a V2X message in a first device, the method including receiving a first V2X message from a second device, identifying information included in the first V2X message, generating a second V2X message using information acquired through a sensor and the first V2X message based on the identifying, and transmitting the second V2X message to the second device.

According to another aspect, there is also provided a method of processing a V2X message, the method including receiving, by a first device, a first V2X message from a second device, identifying, by the first device, information included in the first V2X message, generating, by the first device, a second V2X message using information acquired through a sensor and the first V2X message based on the identifying, transmitting, by the first device, the second V2X message to the second device, and operating the second device based on the second V2X message.

According to another aspect, there is also provided a device for processing a vehicle to everything (V2X) message, the device including a communicator, and a controller configured to receive a first V2X message from another device through the communicator, identify information included in the first V2X message, generate a second V2X message using information acquired through a sensor and the first V2X message based on the identifying, and transmit the second V2X message to the other device through the communicator.

Specific details of example embodiments are included in the detailed description and drawings.

According to the present disclosure, it is possible to provide a second device that transmits a first V2X message to a first device and receives, from the first device, a second V2X message generated by the first device through a correction of the first V2X message, thereby identifying new information or more accurate information. Specifically, the second device may receive the second V2X message generated by the first device, update information in which an error may occur or information difficult to be determined by the second device itself, and perform verification on such information.

Effects are not limited to the aforementioned effects, and other effects not mentioned will be clearly understood by those skilled in the art from the description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 illustrates an example of a method of processing a vehicle to everything (V2X) message according to an example embodiment;

FIG. 5 illustrates another example of a method of processing a V2X message according to an example embodiment;

FIG. 6 illustrates an example of processing a V2X message according to an example embodiment;

FIG. 7 illustrates another example of processing a V2X message according to an example embodiment;

FIG. 8 illustrates another example of processing a V2X message according to an example embodiment;

FIG. 9 is a block diagram illustrating a device for processing a V2X message according to an example embodiment;

FIG. 10 illustrates another example of a method of processing a V2X message according to an example embodiment;

FIG. 11 is a block diagram illustrating a wireless communication system to which the methods proposed in the present disclosure are applicable;

FIG. 12 is a diagram illustrating an example of a signal transmission and reception method performed in a wireless communication system;

FIG. 13 illustrates an example of basic operations of an autonomous vehicle and a 5G network in a 5G communication system; and

FIG. 14 illustrates an example of basic operations between a vehicle and another vehicle using 5G communication.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The terms used in the embodiments are selected, as much as possible, from general terms that are widely used at present while taking into consideration the functions obtained in accordance with the present disclosure, but these terms may be replaced by other terms based on intentions of those skilled in the art, customs, emergency of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

In addition, in this specification, “artificial Intelligence (AI)” refers to the field of studying artificial intelligence or a methodology capable of making the artificial intelligence, and “machine learning” refers to the field of studying methodologies that define and solve various problems handled in the field of artificial intelligence. The machine learning is also defined as an algorithm that enhances performance for a certain operation through a steady experience with respect to the operation.

An “artificial neural network (ANN)” may refer to a general model for use in the machine learning, which is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output the value of an activation function concerning signals input through the synapse, weights, and deflection thereof.

The model parameters refer to parameters determined by learning, and include weights for synaptic connection and deflection of neurons, for example. Then, hyper-parameters refer to parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

The machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by the artificial neural network when learning data is input to the artificial neural network. The unsupervised learning may refer to a learning method for the artificial neural network in the state in which no label for learning data is given. The reinforcement learning may refer to a learning method in which an agent defined in a certain environment learns to select a behavior or a behavior sequence that maximizes cumulative compensation in each state.

The machine learning realized by a deep neural network (DNN) including multiple hidden layers among artificial neural networks is also called deep learning, and the deep learning is a part of the machine learning. In the following description, the machine learning is used as a meaning including the deep learning.

In addition, in this specification, a vehicle may be an autonomous vehicle. “Autonomous driving” refers to a self-driving technology, and an “autonomous vehicle” refers to a vehicle that performs driving without a user's operation or with a user's minimum operation. In addition, the autonomous vehicle may refer to a robot having an autonomous driving function.

For example, autonomous driving may include all of a technology of maintaining the lane in which a vehicle is driving, a technology of automatically adjusting a vehicle speed such as adaptive cruise control, a technology of causing a vehicle to automatically drive in a given route, and a technology of automatically setting a route, along which a vehicle drives, when a destination is set.

Here, a vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, embodiments of the present disclosure will be described in detail with reference to the drawings.

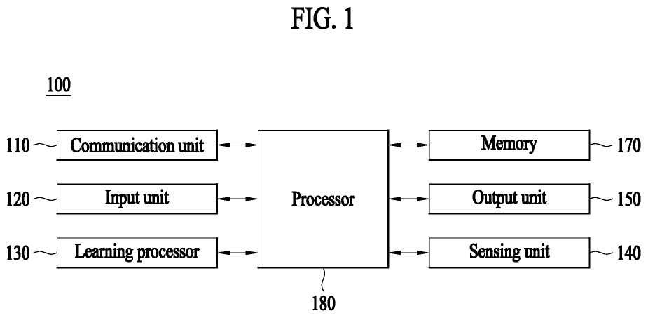

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, AI device 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), (5th Generation Mobile Telecommunication)(5G), wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a LIDAR, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

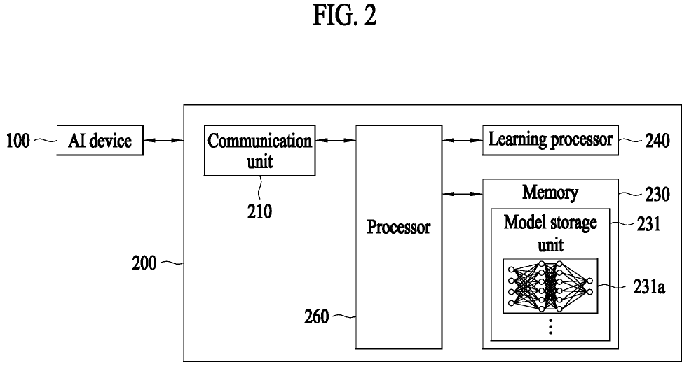

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

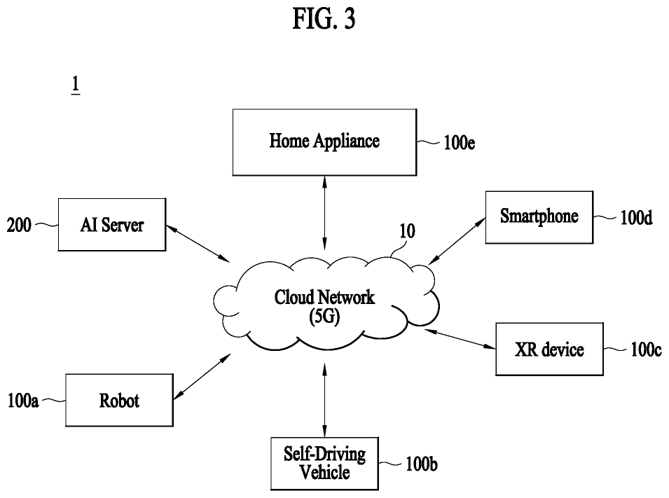

FIG. 3 illustrates an AI system 1 according to an embodiment of the present disclosure.

Referring to FIG. 3, in AI system 1, at least one of AI server 200, a robot 100a, a self-driving vehicle 100b, an XR device 100c, a smart phone 100d, and a home appliance 100e is connected to a cloud network 10. Here, robot 100a, self-driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, self-driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Self-driving vehicle 100b may be realized into a mobile robot, a vehicle, or an unmanned air vehicle, for example, through the application of AI technologies.

Self-driving vehicle 100b may include an autonomous driving control module for controlling an autonomous driving function, and the autonomous driving control module may mean a software module or a chip realized in hardware. The autonomous driving control module may be a constituent element included in self-driving vehicle 100b, but may be a separate hardware element outside self-driving vehicle 100b so as to be connected to self-driving vehicle 100b.

Self-driving vehicle 100b may acquire information on the state of self-driving vehicle 100b using sensor information acquired from various types of sensors, may detect (recognize) the surrounding environment and an object, may generate map data, may determine a movement route and a driving plan, or may determine an operation.

Here, self-driving vehicle 100b may use sensor information acquired from at least one sensor among a LIDAR, a radar, and a camera in the same manner as robot 100a in order to determine a movement route and a driving plan.

In particular, self-driving vehicle 100b may recognize the environment or an object with respect to an area outside the field of vision or an area located at a predetermined distance or more by receiving sensor information from external devices, or may directly receive recognized information from external devices.

Self-driving vehicle 100b may perform the above-described operations using a learning model configured with at least one artificial neural network. For example, self-driving vehicle 100b may recognize the surrounding environment and the object using the learning model, and may determine a driving line using the recognized surrounding environment information or object information. Here, the learning model may be directly learned in self-driving vehicle 100b, or may be learned in an external device such as AI server 200.

At this time, self-driving vehicle 100b may generate a result using the learning model to perform an operation, but may transmit sensor information to an external device such as AI server 200 and receive a result generated by the external device to perform an operation.

Self-driving vehicle 100b may determine a movement route and a driving plan using at least one of map data, object information detected from sensor information, and object information acquired from an external device, and a drive unit may be controlled to drive self-driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, self-driving vehicle 100b may perform an operation or may drive by controlling the drive unit based on user control or interaction. At this time, self-driving vehicle 100b may acquire interactional intention information depending on a user operation or voice expression, and may determine a response based on the acquired intention information to perform an operation.

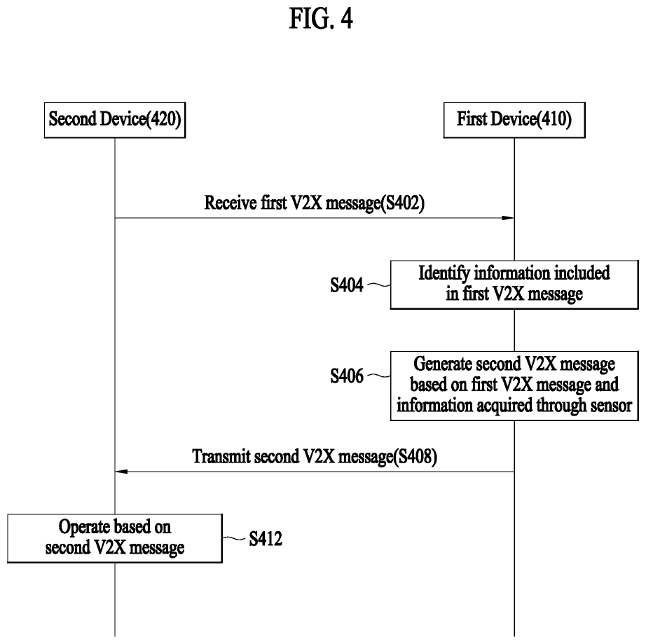

FIG. 4 illustrates a method of processing a V2X message according to an example embodiment.

A first device 410 and a second device 420 may each be a device for processing a V2X message. Specifically, the first device 410 and the second device 420 may each be a device for transmitting and receiving a V2X message and be, for example, any one of a server, an infrastructure, a user terminal, and a vehicle performing V2X communication. Also, the first device 410 and the second device 420 may be included in any one of a server, an infrastructure, a user terminal, and a vehicle performing V2X communication, to process a V2X message.

In operation S402, the first device 410 may receive the first V2X message from the second device 420. Specifically, the second device 420 may transmit the first V2X message to an unspecified number of external parties. The first device 410 may receive the first V2X message transmitted by the second device 420. The second device 420 may broadcast a V2X message at intervals of a predetermined period. For example, the second device 420 may broadcast a basic safety message (BSM) or a personal safety message (PSM) at intervals of a predetermined period.

In operation S404, the first device 410 may identify information included in the first V2X message transmitted from the second device 420. The first device 410 may identify information to be changed or information to be added in the first V2X message transmitted from the second device 420 and determine whether the identified information is to be acquired.

Specifically, the first device 410 may identify information to be changed in the first V2X message and determine whether the identified information is to be acquired through a sensor in the first device 410. For example, the first device 410 may identify first information associated with at least one of a position, a velocity, and a size of the second device 420 included in the first V2X message and determine whether second information associated with at least one of a position, a velocity, and a size of the second device 420 is to be acquired. Here, the second information may be higher in accuracy than the first information identified by the sensor in the first device 410.

In addition, the first device 410 may identify information to be added in the first V2X message and determine whether the identified information is to be acquired through the sensor in the first device 410. For example, the first device 410 may identify the first V2X message in which information on a route of the second device 420 is absent and determine whether the information on the route of the second device 420 is to be acquired through the sensor in the first device 410. When it is determined that the information on the route of the second device 420 is to be acquired, the first device 410 may determine generate a second V2X message by adding the information acquired through the sensor to the first V2X message. When it is determined that the information on the route of the second device 420 is not to be acquired, the first device 410 may not generate the second V2X message. Alternatively, the first device 410 may retransmit the received first V2X message to outside without correcting.

The first device 410 may identify condition information associated with the first V2X message. The condition information may include, for example, information whether a device includes a predetermined sensor, information on a type of a device, and information on a position of a device. For example, the condition information may include information on whether the first device 410 includes a sensor to measure a position of the second device 420 at a predetermined accuracy, information on whether the first device 410 includes a sensor having a higher accuracy than that of a sensor in the second device 420, information on whether the first device 410 corresponds to a road side unit (RSU), and information on whether the first device 410 is present within a predetermined distance from the second device 420. The first device 410 may receive the condition information associated with the first V2X message from the second device 420.

The condition information associated with the first V2X message may further include information on whether a device has an authority to correct the first V2X message. For example, the first device 410 may be previously authorized by the second device 420 to correct the first V2X message. The first device 410 may determine to correct the first V2X message in response to a verification that the received first V2X message is transmitted from the second device 420. Also, the first device 410 may determine whether the device is registered in a set reliable group and determine whether the device has an authority to correct the first V2X message.

In operation S406, in response to the identifying of operation S404, the first device 410 may generate the second V2X message based on the first V2X message and the information acquired through the sensor. Specifically, the first device 410 may generate the second V2X message by correcting the first V2X message based on the information acquired through the sensor. In this disclosure, correcting a V2X message may include both partially or fully changing information included in the V2X message and adding information to the V2X message.

In one example, the first device 410 may acquire information absent in the first V2X message through the sensor of the first device 410 and generate the second V2X message by adding the information acquired through the sensor of the first device 410 to the first V2X message. For example, the second device 420 may transmit, to the first device 410, the first V2X message in which the information on the route of the second device 420 is absent. In this example, the first device 410 may generate the second V2X message by adding the information on the route of the second device 420 acquired through the sensor to the first V2X message.

In another example, the first device 410 may change information of the first V2X message based on the information acquired through the sensor. Specifically, the first device 410 may change predetermined information of the first V2X message to the information acquired through the sensor of the first device 410 when the information acquired through the sensor has a higher accuracy than that of the predetermined information of the first V2X message or when the information acquired through the sensor is different from the predetermined information of the first V2X message. For example, the first device 410 may compare position information of the second device 420 which is predetermined information included in the first V2X message transmitted from the second device 420, to position information of the second device 420 acquired through the sensor of the first device 410. In this example, since the position information of the second device 420 acquired through the sensor of the first device 410 has the higher accuracy, the first device 410 may change the position information of the second device 420 in the first V2X message to the position information of the second device 420 acquired through the sensor of the first device 410.

In operation S408, the first device 410 may transmit the second V2X message to the second device 420. In other words, the first device 410 may retransmit the second V2X message generated by correcting the first V2X message transmitted from the second device 420. The first device 410 may transmit the second V2X message to an unspecified number of external parties. The second device 420 may receive the second V2X message transmitted by the first device 410. Also, the second device 420 may identify a device transmitting the second V2X message based on a V2X identification (ID) when receiving the second V2X message.

The first device 410 may periodically receive the first V2X message from the second device 420. For example, before the first V2X message received from the second device 420 in a first period is corrected and then retransmitted, the first V2X message may be received from the second device 420 in a second period. In this example, instead of correcting and retransmitting the first V2X message received in the first period, the first device 410 may retransmit the second V2X message generated by correcting the first V2X message received in the second period.

In operation S412, the second device 420 may operate based on the second V2X message transmitted from the first device 410. Specifically, the second device 420 may identify the information changed in the second V2X message in comparison to the first V2X message transmitted to the first device 410 and operate based on the changed information.

The second device 420 may determine whether the second V2X message transmitted from the first device 410 is the second V2X message generated by correcting the first V2X message transmitted to the first device 410. For example, the second device 420 may identify information in the second V2X message transmitted from the first device 410, thereby determining whether the second V2X message is a V2X message generated by correcting the first V2X message.

The second device 420 may identify the information changed in the second V2X message transmitted from the first device 410 in comparison to the first V2X message transmitted to the first device 410 in operation S402 and update a database of the second device 420 based on the changed information. Specifically, the second device 420 may update the database by identifying new information or information having a higher accuracy in the second V2X message in comparison to the first V2X message. For example, when the information changed by the first device 410 in the second V2X message is the position information of the second device 420, the second device 420 may update the position information of the second device 420 based on the information changed by the first device 410.

The second device 420 may identify the information changed in the second V2X message in comparison to the first V2X message transmitted to the first device 410 in operation S402 and transmit a third V2X message including the changed information to outside. For example, the second device 420 may periodically transmit a V2C message including information associated with a position, a velocity, and a direction of the second device 420 to the first device 410. In the first period, the second device 420 may transmit the first V2X message including first information associated a position, a velocity, and a direction of the second device 420 to the first device 410. The first device 410 may acquire second information associated with a position, a velocity, and a direction of the second device 420 through a sensor, generate the second V2X message by changing the first information in the first V2X message to the second information, and transmit the second V2X message to the second device 420. The second device 420 may transmit the second information included in the second V2X message and transmit, in the second period, the third V2X message including the second information to the first device 410. Also, in the second period, the first device 410 may acquire third information associated with a position, a velocity, and a direction of the second device 420 through the sensor and compare the second information included in the third V2X message to the third information. When the second information is the same as the third information, the first device 410 may not generate a fourth V2X message. When the second information is different from the third information, the first device 410 may change the second information in the third V2X message to the third information, thereby generating the fourth V2X message.

The second device 420 may transmit the first V2X message to the first device 410 and receive the second V2X message generated by correcting the first V2X message from the first device 410, thereby identifying new information or information having a higher accuracy. Specifically, the second device 420 may receive the second V2X message generated by the first device 410, update information in which an error may occur or information difficult to be determined by the second device 420 itself, and perform verification on such information.

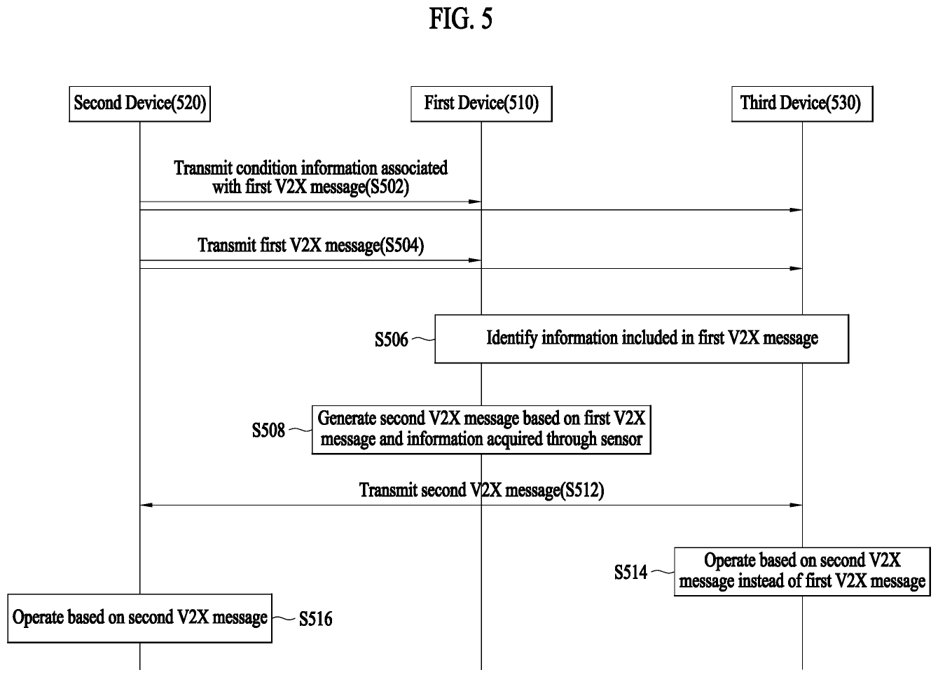

FIG. 5 illustrates another example of a method of processing a V2X message according to an example embodiment.

A first device 510, a second device 520, and a third device 530 may each be a device for processing a V2X message. Specifically, the first device 510, the second device 520, and the third device 530 may each be a device for transmitting and receiving a V2X message and be, for example, one of a server, an infrastructure, a user terminal, and a vehicle performing V2X communication. Also, the first device 510, the second device 520, and the third device 530 may be included in one of a vehicle performing V2X communication, a user terminal, an infrastructure, and a server, to process a V2X message.

In operation S502, the second device 520 may transmit condition information associated with the first V2X message to outside. Specifically, the second device 520 may transmit condition information associated with a first V2X message to the first device 510 and the third device 530. The condition information associated with the first V2X message may include information for requesting the first V2X message to be corrected. In addition, the condition information may include, for example, information on whether a device includes a predetermined sensor, information on a type of a device, information on a position of a device, and information on whether a device has an authority to correct a V2X message.

The second device 520 may transmit the condition information associated with the first V2X message to outside based on a predetermined condition. As an example, when entering a predetermined region, the second device 520 may transmit information for requesting the first V2X message to be corrected, to outside. As another example, when it is determined that an accuracy of a sensor of the second device 520 is less than a predetermined reference, the second device 520 may transmit the information for requesting the first V2X message to be corrected, to outside.

In operation S504, the second device 520 may transmit the first V2X message to the first device 510 and the third device 530. Specifically, the second device 520 may transmit the first V2X message to an unspecified number of external parties. The first device 510 and the third device 530 may receive the first V2X message transmitted by the second device 520. The second device 520 may broadcast the first V2X message at intervals of a predetermined interval.

The second device 520 may broadcast the first V2X message such that devices having predetermined identification information receive the first V2X message. The predetermined identification information may be determined based on information included in the first V2X message. For example, the first V2X message may include identification information such that the first device 510 allowed to correct the first V2X message receives the first V2X message.

The first V2X message may include at least one of information for identifying the second device 520 and information for identifying the first V2X message. The information for identifying the first V2X message may be generated based on at least a portion of the information for identifying the second device 520 and also be generated based on information included in the first V2X message.

In operation S506, each of the first device 510 and the third device 530 may identify information included in the first V2X message transmitted from the second device 520. For example, the first device 510 may identify information to be changed in the first V2X message transmitted from the second device 520 and determine that the identified information is to be acquired through a sensor. The first device 510 may determine to correct the first V2X message to generate a second V2X message. In addition, the third device 530 may identify information to be added in the first V2X message transmitted from the second device 520 and determine that the identified information is not to be acquired through the sensor. Thus, the third device 530 may determine that the first V2X message is not to be corrected.

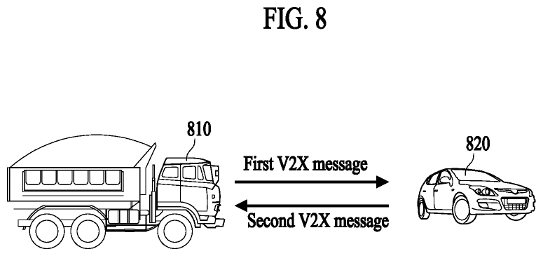

In operation S508, in response to the identifying of operation S506, the first device 510 may generate the second V2X message based on the first V2X message and the information acquired through the sensor. When the first device 510 corresponds to the condition information associated with the first V2X message, the first device 510 may correct the first V2X message based on the information acquired through the sensor, thereby generating the second V2X message. For example, when the first device 510 has an authority to correct the first V2X message, the first device 510 may generate the second V2X message. Conversely, when the first device 510 does not correspond to the condition information associated with the first V2X message, the first device 510 may transmit the first V2X message to the second device 520 instead of generating the second V2X message. Since operation S508 of FIG. 8 corresponds to operation S406 of FIG. 4, repeated description will be omitted.

In operation S512, the first device 510 may transmit the second V2X message to the second device 520 and the third device 530. Specifically, the first device 510 may broadcast the second V2X message to an unspecified number of external parties. The second device 520 and the third device 530 may receive the second V2X message broadcast by the first device 510.

The second V2X message may include at least one of information for identifying the first device 510, information on the first V2X message transmitted from the second device 520, and indication information that indicates corrected information in comparison to the first V2X message. Thus, the second device 520 and the third device 530 receiving the second V2X message may identify corrected information in comparison to the first V2X message based on the information included in the second V2X message.

In the example embodiment, V2X messages of operations S502, S504, and S512 may be transmitted on the same type of channel. The same type of channel may be, for example, a channel for broadcasting or a shared channel. Some V2X messages may be transmitted on the channel for broadcasting and some V2X messages may be transmitted on the shared channel. For example, a message of operation S504 may be transmitted on the channel for broadcasting and a message of operation S512 may be transmitted on the shared channel. In order to transmit data on the shared channel, the first device 510 may acquire at least one of the information for identifying the second device 520 and the information for identifying the third device 530 before operation S512 and transmit a V2X message on the shared channel based on the acquired information.

In operation S514, the third device 530 may operate based on the second V2X message transmitted from the first device 510 in operation S512 instead of the first V2X message transmitted from the second device 520 in operation S504. Specifically, in comparison to the first V2X message transmitted from the second device 520, the third device 530 may verify that the second V2X message transmitted from the third device 530 is a message retransmitted by correcting the first V2X message transmitted from the second device 520. Thus, the third device 530 may process the second V2X message transmitted from the first device 510 instead of the first V2X message transmitted from the second device 520. Conversely, the third device 530 may verify that the second V2X message transmitted from the first device 510 is a message retransmitted without correcting the first V2X message transmitted from the second device 520, in comparison to the first V2X message transmitted from the second device 520. Thus, the third device 530 may process the first V2X message transmitted from the second device 520 and neglect the second V2X message transmitted from the first device 510. The third device 530 may identify predetermined information in a V2X message and determine whether the V2X message is a message retransmitted through a correction or a message retransmitted without correcting.

Also, the third device 530 may receive, from a fourth device, a V2X message retransmitted by correcting a V2X message transmitted from the first device 510, compare the corrected V2X message of the second device 520 to the corrected V2X message of the fourth message, and operate based on a V2X message having a higher accuracy therebetween.

In operation S516, the second device 520 may operate based on the second V2X message transmitted from the first device 510. Since operation S516 of FIG. 5 corresponds to operation S412 of FIG. 4, repeated description will be omitted.

In the example embodiment, each of the V2X messages may be transmitted on the same channel or different channels. Also, each device may determine whether to correct the V2X message and a time required to process the V2X message and send a response, based on a channel on which the corresponding message is received.

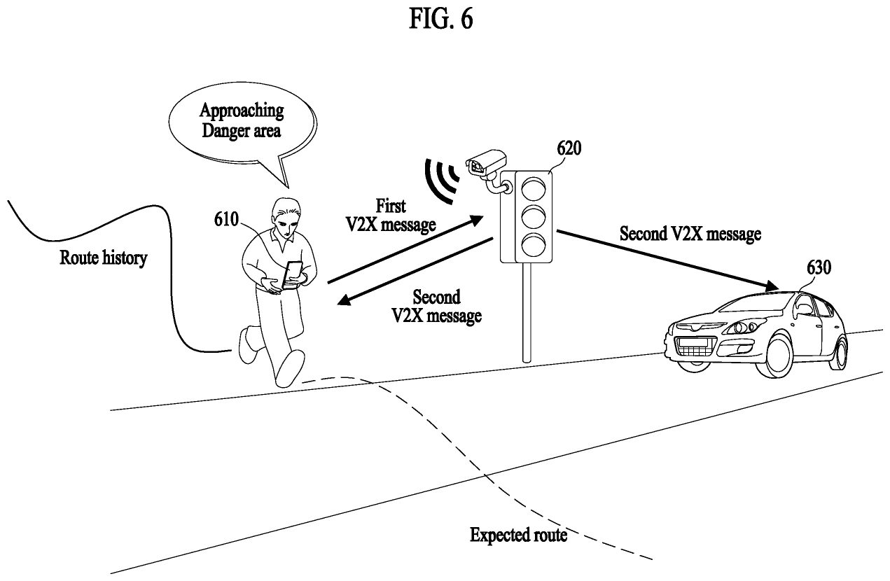

FIG. 6 illustrates an example of processing a V2X message.

A user terminal 610 may transmit information for requesting a first V2X message to be corrected to outside in response to a user approaching a danger area and transmit the first V2X message to outside. Specifically, the user terminal 610 may transmit a message requesting route history information and expected route information of the user terminal 610 to be added to the first V2X message, to outside. Also, the user terminal 610 may transmit the first V2X message in which the route history information and the expected route information are absent to outside. The user terminal 610 may set an RSU which includes a camera and is present within a predetermined distance from the user terminal 610, to be a device allowed to correct the first V2X message.

An RSU 620 may identify information included in the first V2X message transmitted from the user terminal 610. Specifically, the RSU 620 may identify the route history information and the expected route information of the user terminal 610 as information to be added to the first V2X message. Also, the RSU 620 may verify that the RSU 620 satisfies a condition for a device allowed to correct the first V2X message.

The RSU 620 may acquire information on a route of the user terminal 610 through the camera and acquire the route history information and the expected route information of the user terminal 610 based on the information on the route. For example, the RSU 620 may generate the expected route information of the user terminal 610 using a route prediction algorithm. In this example, the RSU 620 may generate a second V2X message by correcting the first V2X message based on the acquired route history information and the acquired expected route information of the user terminal 610. Specifically, the RSU 620 may generate the second V2X message by adding the acquired route history information and the acquired expected route information of the user terminal 610 to the first V2X message transmitted from the user terminal 610.

The RSU 620 may transmit the second V2X message to outside. Specifically, the RSU 620 may transmit the second V2X message to the user terminal 610 and a vehicle 630.

The user terminal 610 may operate based on the second V2X message transmitted from the RSU 620. Specifically, the user terminal 610 may identify the route history information and the expected route information of the user terminal 610 in the second V2X message and update a database. Thus, when transmitting the third V2X message after the second V2X message is received, the user terminal 610 may transmit the third V2X message including the identified route history information and the identified expected route information, to outside.

The vehicle 630 may receive the second V2X message from the RSU 620 and compare the received second V2X message to the first V2X message received in advance from the user terminal 610. The vehicle 630 may identify the route history information and the expected route information of the user terminal 610 in the second V2X message in comparison to the first V2X message received in advance, and operate based on the identified information. For example, the vehicle 630 may identify the route history information and the expected route information of the user terminal 610, thereby correcting or maintaining a driving route.

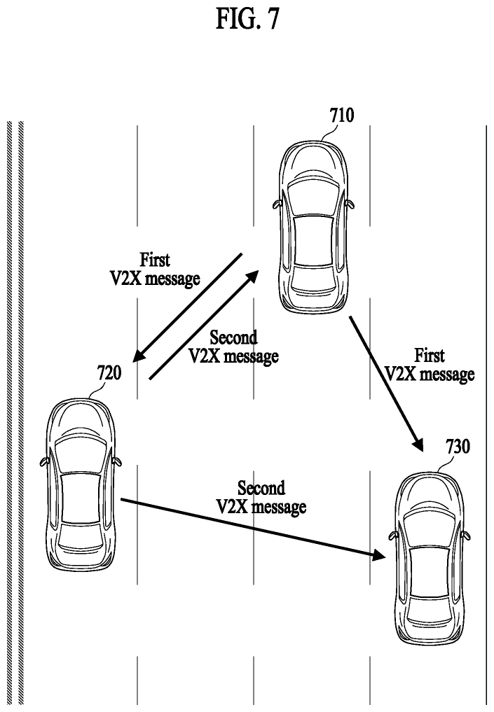

FIG. 7 illustrates another example of processing a V2X message.

A first vehicle 710 may transmit a first V2X message including position information of the first vehicle 710 to outside. For example, the first vehicle 710 may transmit a BSM including the position information of the first vehicle 710 to a second vehicle 720 and a third vehicle 730.

The second vehicle 720 may identify information included in the first V2X message transmitted from the first vehicle 710. Specifically, the second vehicle 720 may identify position information of the first vehicle 710 in the first V2X message, determine that a position recognition accuracy of the second vehicle 720 is higher than a position recognition accuracy of the first vehicle 710 based on the identified information, and determine to correct the first V2X message.

The second vehicle 720 may measure a position of the first vehicle 710 using a sensor in the second vehicle 720 and correct the first V2X message based on position information of the measured position of the first vehicle 710, thereby generating the second V2X message. In other words, the second vehicle 720 may update position information of the first vehicle 710 in the first V2X message with the position information of the position measured by the second vehicle 720, thereby generating the second V2X message.

The second vehicle 720 may transmit the second V2X message to outside. Specifically, the second vehicle 720 may transmit the second V2X message to the first vehicle 710 and the third vehicle 730.

The first vehicle 710 may operate based on the second V2X message transmitted from the second vehicle 720. Specifically, the first vehicle 710 may identify changed position information of the first vehicle 710 in the second V2X message and may correct position information of the first vehicle 710 stored in a database based on the changed position information of the first vehicle 710. For example, the first vehicle 710 may identify a GPS error of the first vehicle 710 by comparing the identified position information of the first vehicle 710 to the stored position information of the first vehicle 710, measure a position of the first vehicle 710 based on the identified GPS error, and store the measured position. Also, the first vehicle 710 may transmit a third V2X message including the corrected position information of the first vehicle 710 to outside.

The third vehicle 730 may receive the second V2X message from the second vehicle 720 and compare the received second V2X message to the first V2X message received in advance from the first vehicle 710. The third vehicle 730 may identify position information of the first vehicle 710 in the second V2X message in comparison to the received first V2X message and update the stored position information of the first vehicle 710 based on the identified position information of the first vehicle 710. In other words, the third vehicle 730 may change the position information of the first vehicle 710 from the position information of the first vehicle 710 in the first V2X message transmitted from the first vehicle 710, to the position information of the first vehicle 710 in the second V2X message transmitted from the second vehicle 720.

FIG. 8 illustrates another example of processing a V2X message.

A first vehicle 810 may transmit a first V2X message including size information of the first vehicle 810 to outside. The first vehicle 810 may be difficult to measure a current size of the first vehicle 810 and thus, transmit the first V2X message including predetermined size information to outside. For example, when the first vehicle 810 is a freight vehicle, it is difficult to acquire real-time height information of the first vehicle 810. In this example, the first vehicle 810 may transmit the first V2X message including predetermined height information to outside. Also, the first vehicle 810 may transmit a message requesting the size information of the first vehicle 810 in the first V2X message to be updated, to a second vehicle 820. For example, when setting a driving route, the first vehicle 810 may perform transmission and a request for update of the first V2X message.

The second vehicle 820 may determine whether to correct the first V2X message transmitted from the first vehicle 810. Specifically, the second vehicle 820 may update the size information of the first vehicle 810 in the first V2X message in response to the request for update from the first vehicle 810 and determine that the first V2X message is to be corrected.

The second vehicle 820 may measure a size of the first vehicle 810 using a sensor in the second vehicle 820 and correct the first V2X message based on size information of the measured size of the first vehicle 810, thereby generating the second V2X message. In other words, the second vehicle 820 may update size information of the first vehicle 810 in the first V2X message with the size information of the size measured by the second vehicle 820, thereby generating the second V2X message.

The second vehicle 820 may transmit the second V2X message to the first vehicle 810.

The first vehicle 810 may operate based on the second V2X message transmitted from the second vehicle 820. Specifically, the first vehicle 810 may identify the size information of the first vehicle 810 updated in the second V2X message and change size information of the first vehicle 810 previously stored in a database based on the updated size information of the first vehicle 810. Also, the first vehicle 810 may set a driving route based on the changed size information of the first vehicle 810. For example, when the first vehicle 810 of a changed size is not possible to pass a specific tunnel, the first vehicle 810 may set a driving route so as to avoid the tunnel.

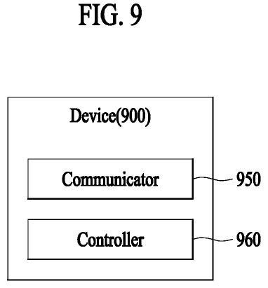

FIG. 9 is a block diagram illustrating a device for processing a V2X message.

A device 900 may include a communicator 950 and a controller 960. FIG. 9 illustrates only components of the device 900 related to the present embodiment. Therefore, it will be understood by those skilled in the art that other general-purpose components may be further included in addition to the components illustrated in FIG. 9.

The communicator 950 may communicate with another device. The communicator 950 may use communications technology such as Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, and Near Field Communication (NFC), for example.

The communicator 950 is capable of performing V2X communication and thus, may transmit and receive a V2X message.

The controller 960 may control an overall operation of the device 900 and process data and a signal. The controller 960 may include at least one hardware unit. In addition, the controller 960 may operate through at least one software module generated by executing program codes stored in a memory.

In one example, the controller 960 may acquire a first V2X message through the communicator 950 and identify information on the acquired first V2X message. As an example, the controller 960 may identify information to be changed or information to be added in the acquired first V2X message and determine whether the identified information is to be acquired. As another example, the controller 960 may acquire condition information associated with the first V2X message through the communicator 950 and determine whether the device 900 corresponds to the condition information. When it is determined to correct the first V2X message, the controller 960 may correct the first V2X message based on information acquired through a sensor, thereby generating a second V2X message. Specifically, the controller 960 may change the information to be changed in the first V2X message to the information acquired through the sensor in the device 900, thereby generating the second V2X message. The controller 960 may transmit the second V2X message through the communicator 950 to outside.

In another example, the controller 960 may transmit the first V2X message through the communicator 950 to outside and receive the second V2X message from the outside. The controller 960 may operate based on the second V2X message. Specifically, the controller 960 may identify the information changed in the second V2X message in comparison to the first V2X message and update a database of the device 900 based on the changed information. In addition, the controller 960 may identify the information changed in the second V2X message in comparison to the first V2X message and transmit a third V2X message including the changed information through the communicator 950 to outside.

In another example, the controller 960 may receive the first V2X message through the communicator 950, and then receive the second V2X message. When the second V2X message is received, the controller 960 may verify that the second V2X message is a message retransmitted after correcting the first V2X message received in advance in comparison to the first V2X message. Thus, the controller 960 may operate based on the second V2X message instead of the first V2X message.

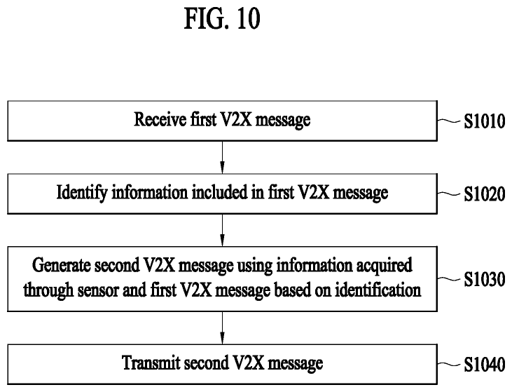

FIG. 10 illustrates another example of a method of processing a V2X message.

The method of FIG. 10 may be performed by each component of the device 900 of FIG. 9 and repeated description will be omitted.

In operation S1010, the device 900 may receive a first V2X message.

In operation S1020, the device 900 may identify information included in the first V2X message received in operation S1010. As an example, the device 900 may identify information to be changed or information to be added in the first V2X message and determine whether the identified information is to be acquired. As another example, the device 900 may acquire condition information associated with the first V2X message and determine whether the device 900 corresponds to the condition information.

In operation 51030, the device 900 may generate a second V2X message using information acquired through a sensor and the first V2X message based on the identifying of operation S1020. Specifically, the device 900 may change the information to be changed in the first V2X message to the information acquired through the sensor in the device 900, thereby generating the second V2X message.

In operation S1040, the device 900 may transmit the second V2X message to outside.

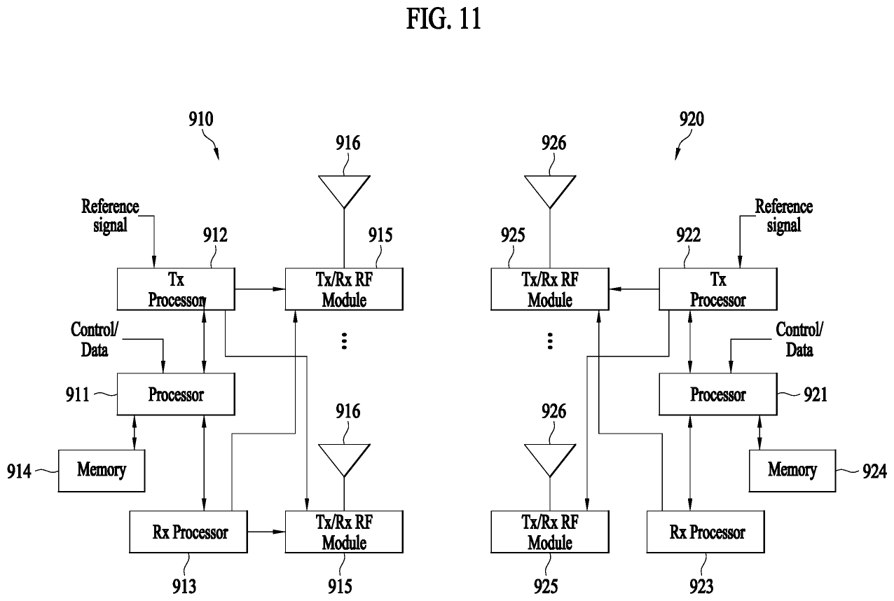

FIG. 11 is a block diagram illustrating a wireless communication system to which the methods proposed in the present disclosure are applicable.

Referring to FIG. 11, a device including an autonomous driving vehicle, hereinafter also referred to as “autonomous driving device”, may be defined as a first communication device as indicated by a reference numeral 910. A processor 911 may perform a detailed operation for autonomous driving.

A 5G network including another vehicle that communicates with the autonomous driving device may be defined as a second communication device, as indicated by a reference numeral 920. A processor 921 may perform a detailed operation for autonomous driving.

The 5G network may also be referred to as the first communication device and the autonomous driving device may also be referred to as the second communication device.

The first communication device or the second communication device may be, for example, a base station, a network node, a transmitting terminal, a receiving terminal, a wireless device, a wireless communication device, and an autonomous driving device.

A terminal or user equipment (UE) may include, for example, a vehicle, a mobile phone, a smartphone, a laptop computer, a digital broadcast terminals, a personal digital assistant (PDA), a portable multimedia player (PMP), a navigator, a slate PC, a tablet PC, an ultrabook, and a wearable device such as a smartwatch, a smart glass, and a head mounted display (HMD), and the like. For example, the HMD may be a display device to be worn on a head. For example, the HMD may be used to implement a virtual reality (VR), an augmented reality (AR), or a mixed reality (MR). Referring to FIG. 11, the first communication device 910 and the second communication device 920 may include the processors 911 and 921, the memory 914 and 924, one or more Tx/Rx radio frequency (RF) modules 915 and 925, Tx processors 912 and 922, Rx processors 913 and 923, and antennas 916 and 926. The Tx/Rx module may also be referred to as a transceiver. Each of the Tx/Rx RF modules 915 and 925 may transmit a signal using the antennas 916 and 926. The processor may implement the functions, processes, and/or methods described herein. The processor 921 may be associated with the memory 924 that stores a program code and data. The memory may also be referred to as a computer-readable medium. Specifically, in downlink (DL) communication, for example, communication from the first communication device to the second communication device, the Tx processor 912 may implement various signal processing functions for a layer L1, that is, a physical layer. The Rx processor may implement various signal processing functions of the layer L1, that is, a physical layer.

Uplink (UL) communication, for example, communication from the second communication device to the first communication device may be processed in the first communication device 910 in a manner similar to that described with respect to the function of the receiver in the second communication device 920. Each of the Tx/Rx modules 925 may receive a signal using the antenna 926. Each of the Tx/Rx modules may provide a radio frequency (RF) carrier wave and information to the Rx processor 923. The processor 921 may be associated with the memory 924 that stores a program code and data. The memory may also be referred to as a computer-readable medium.

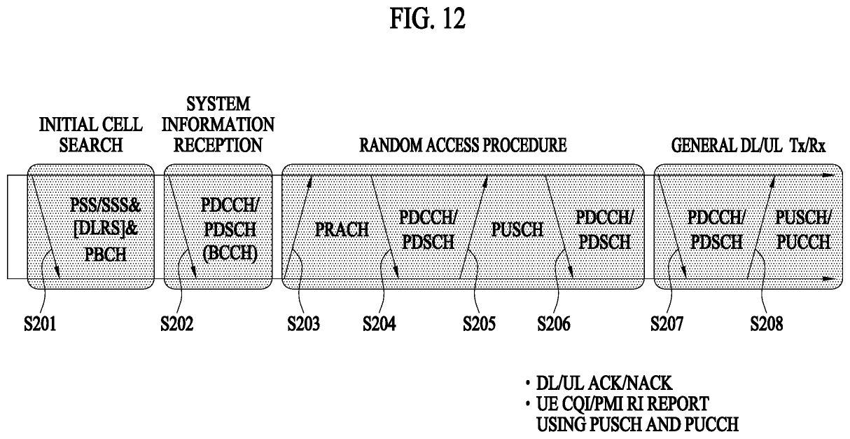

FIG. 12 illustrates an example of a signal transmission and reception method performed in a wireless communication system.

Referring to FIG. 12, in operation S201, when UE is powered on or enters a new cell, the UE performs an initial cell search procedure such as acquisition of synchronization with a BS. To this end, the UE may adjust synchronization with the BS by receiving a primary synchronization channel (P-SCH) and a secondary synchronization channel (S-SCH) from the BS and acquire information such as a cell identifier (ID). In an LTE system and a new radio (NR) system, the P-SCH and the S-SCH may also be referred to as a primary synchronization signal (PSS) and a secondary synchronization signal (SSS), respectively. After the initial cell search, the UE may acquire in-cell broadcast information by receiving a physical broadcast channel from the BS. In the initial cell search procedure, the UE may monitor a DL channel state by receiving a downlink reference signal (DL RS). When the initial cell search procedure is terminated, in operation S202, the UE may acquire more detailed system information by receiving a physical downlink control channel (PDCCH) and a physical downlink shared channel (PDSCH) based on information carried on the PDCCH.

Meanwhile, if the UE initially accesses the BS or if radio resources for signal transmission are absent, the UE may perform a random access procedure with respect to the BS in operations S203 through S206. To this end, the UE may transmit a specific sequence as a preamble through a physical random access channel (PRACH) in operations S203 and S205 and receive a random access response (RAR) message for the preamble through the PDCCH and the PDSCH corresponding to the PDCCH in operations S204 and S206. In the case of a contention-based RACH, the UE may additionally perform a contention resolution procedure.

After performing the above procedures, the UE may perform PDCCH/PDSCH reception in operation S207 and perform physical uplink shared channel (PUSCH)/physical uplink control channel (PUCCH) transmission in operation S208, as a general UL/DL signal transmission procedure. For example, the UE may receive downlink control information (DCI) through the PDCCH. The UE may monitor a set of PDCCH candidates in monitoring occasions set in one or more control element sets (CORESETs) on a serving cell based on corresponding search space configurations. The set of PDCCH candidates to be monitored by the UE may be defined in terms of search space sets. The search space set may be a common search space set or a UE-specific search space set. The CORESET may include a set of (physical) resource blocks having a time duration of one to three orthogonal frequency division multiplexing (OFDM) symbols. A network may set the UE to have a plurality of CORESETs. The UE may monitor PDCCH candidates in one or more search space sets. Here, the monitoring may indicate attempting to decode the PDCCH candidate(s) in the search space. When the UE succeeds in decoding one of the PDCCH candidates in the search space, the UE may determine that the PDCCH is detected in the corresponding PDCCH candidate and perform PDSCH reception or PUSCH transmission based on the DCI in the detected PDCCH. The PDCCH may be used to schedule DL transmission on the PDSCH and UL transmission on the PUSCH. Here, the DCI on the PDCCH may include downlink assignment, that is, a downlink grant (DL grant) including at least a modulation and coding format and resource allocation information in association with a downlink shared channel, or an uplink grant (UL grant) including a modulation and coding formal and resource allocation information in association with an uplink shared channel.

An initial access (IA) procedure performed in a 5G communication system will be further described with reference to FIG. 12.

UE may perform cell search, system information acquisition, beam alignment for initial access, DL measurement, and the like based on a synchronization signal block (SSB). The term “SSB” may be interchangeably used with the term “synchronization signal/physical broadcast channel (SS/PBCH) block”.

The SSB may include a PSS, an SSS, and a PBCH. The SSB may include four consecutive OFDM symbols. For each of the OFDM symbols, the PSS, the PBCH, the SSS/PBCH, or the PBCH may be transmitted. The PSS and the SSS may each include one OFDM symbols and 127 subcarriers. The PBCH may include three OFDM symbols and 576 subcarriers.

The cell search may indicate a process in which the UE acquires time/frequency synchronization of a cell and detect a cell ID, for example, a physical layer cell ID (PCI) of the cell. The PSS may be used to detect a cell ID in a cell ID group. The SSS may be used to detect the cell ID group. The PBCH may be used for SSB (time) index detection and half-frame detection.

336 cell ID groups may be present. Three cell IDs may belong to each of the cell ID groups. Information on a cell ID group to which a cell ID of a cell belongs may be provided/acquired through an SSS of the cell. Information on the cell ID among 336 cells in the cell ID may be provided/acquired through the PSS.

The SSB may be periodically transmitted based on an SSB periodicity. When performing the initial cell search, a basic SSB periodicity assumed by the UE may be defined as 20 milliseconds (ms). After the cell connection, the SSB periodicity may be set to one of 5 ms, 10 ms, 20 ms, 40 ms, 80 ms, and 160 ms by a network, for example, the BS.

Acquisition of system information (SI) will be described as follows.

The SI may be divided into a master information block (MIB) and a plurality of system information blocks (SIBs). The SI other than the MIB may be referred to as remaining minimum system information (RMSI). The MIB may include information/parameter for monitoring the PDCCH that schedules the PDSCH carrying SystemInformationBlock1 (SIB1), and may be transmitted by the BS through the PBCH of the SSB. The SIB1 may include information associated with availabilities and scheduling (e.g., a transmission period and an SI-window size) of remaining SIBs (hereinafter, referred to as “SIBx”, x being an integer greater than or equal to 2). The SIBx may be included in an SI message and transmitted through the PDSCH. Each SI message may be transmitted within a time window, that is, an SI-window occurring periodically.

A random access (RA) procedure performed in the 5G communication system will be further described with reference to FIG. 12.

The RA procedure may be used for various purposes. For example, the RA procedure may be used for network initial access, handover, and UE-triggered UL data transmission. The UE may acquire UL synchronization and UL transmission resources through the RA procedure. The RA procedure may include a contention-based RA procedure and a contention-free RA procedure. A detailed process of the contention-based RA procedure is described as follows.

The UE may transmit an RA preamble through the PRACH as Msg1 of the RA procedure in the UL communication. RA preamble sequences having two different lengths may be supported. A large sequence length of 839 may be applied to subcarrier spacing of 1.25 and 5 kilohertz (kHz). A small sequence length of 139 may be applied to subcarrier spacing of 15, 30, 60, and 120 kHz.

When the BS receives the RA preamble from the UE, the BS may transmit a random access response (RAR) message Msg2 to the UE. The PDCCH that schedules the PDSCH carrying the RAR may cyclic redundancy check (CRC)-masked with an RA radio network temporary identifier (RA-RNTI), and then transmitted. The UE may detect the PDCCH masked with the RA-RNTI and receive the RAR from the PDSCH scheduled by the DCI carried by the PDCCH. The UE may verify whether a preamble transmitted by the UE, that is, RAR information for the Msg1 is present in the RAR. Whether RA information for the Msg1 transmitted by the UE is present may be determined based on whether an RA preamble ID for the preamble transmitted by the UE is present. When a response to the Msg1 is absent, the UE may retransmit an RACH preamble within a predetermined number of times while performing power ramping. The UE may calculate PRACH transmitting power for retransmitting a preamble based on a most recent path loss and a power ramping counter.

The UE may perform the UL transmission on the uplink shared channel based on the RAR information as transmission of Msg3 in the random access procedure. The Msg3 may include an RRC connection request and a UE identifier. As a response to the Msg3, the network may transmit Msg4, which may treated as a contention resolution message on the DL. By receiving the Msg4, the UE may enter an RRC-connected state.

Ultra-reliable and low latency communication (URLLC) transmission defined in the NR may be transmission associated with: (1) a relatively low traffic amount; (2) a relatively low arrival rate; (3) an ultra-low latency requirement (e.g., 0.5 and 1 ms); (4) a relatively short transmission duration (e.g., 2 OFDM symbols); and (5) an urgent service/message. In the case of the UL, to satisfy a more stringent latency requirement, transmission of a specific type of traffic, for example, URLLC may be multiplexed with another transmission scheduled in advance, for example, enhanced Mobile Broadband communication (eMBB). As one method related thereto, information indicating that preemption is to be performed on predetermined resources is transmitted to the UE scheduled in advance, so that URLLC UE uses the corresponding resources for UL transmission.

In a case of the NR, dynamic resource sharing between the eMBB and the URLLC may be supported. eMBB and URLLC services may be scheduled on non-overlapping time/frequency resources. The URLLC transmission may occur on resources scheduled with respect to ongoing eMBB traffic. eMBB UE may not know whether PDSCH transmission of the corresponding UE is partially punctured. Also, due to corrupted coded bits, the UE may not decode the PDSCH. Considering this, a preemption indication may be provided in the NR. The preemption indication may also be referred to as an interrupted transmission indication.

In association with the preemption indication, the UE may receive DownlinkPreemption IE through RRC signaling from the BS. When the UE receives the DownlinkPreemption IE, the UE may be configured with an INT-RNTI provided by a parameter int-RNTI in the DownlinkPreemption IE for monitoring of the PDCCH conveying a DCI format 2_1. The UE may be additionally configured to have a set of serving cells by INT-ConfigurationPerServing Cell including a set of serving cell indices provided by servingCellID and a corresponding set of positions for fields in the DCI format 2_1 by positionInDCI, configured to have information payload size for the DCI format 2_1 by dci-PayloadSize, and configured to have an indication granularity of time-frequency resources by timeFrequencySect.

The UE may receive the DCI format 2_1 from the BS based on the DownlinkPreemption IE.

When the UE detects the DCI format 2_1 for a serving cell in a set of serving cells, the UE may assume that no transmission to the UE is performed in symbols and PRBs indicated by the DCI format 2_1 among a set of symbols and a set of PRBs corresponding to the last monitoring period of a monitoring period to which the DCI format 2_1 belongs. For example, the UE may determine that a signal in the time-frequency resources indicated by the preemption is not the DL transmission scheduled for the UE and thus, decode data based on signals received in remaining resource areas.

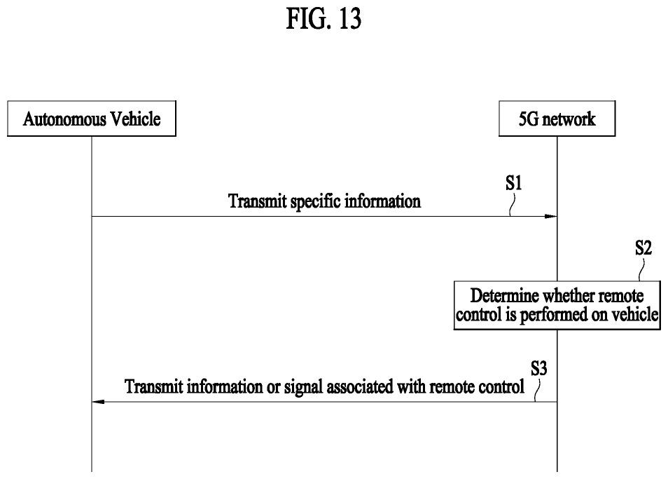

FIG. 13 illustrates an example of basic operations of an autonomous vehicle and a 5G network in a 5G communication system.

In operation S1, the autonomous vehicle may transmit specific information to a 5G network. The specific information may include autonomous driving-related information. In operation S2, the 5G network may determine whether a remote control is performed on the vehicle. Here, the 5G network may include a server or a module for performing an autonomous driving-related remote control. In operation S3, the 5G network may transmit information or a signal associated with the remote control to the autonomous vehicle.

Hereinafter, an operation of the autonomous vehicle using 5G communication will be described in detail with reference to FIGS. 11 and 12 and the aforementioned wireless communication technologies such as a beam management (BM) procedure, URLLC, massive Machine Type Communication (mMTC), and the like.

A basic procedure of an application operation to which the method proposed in the present disclosure and eMBB technology of the 5G communication are applicable will be described.

Likewise operations S1 and S3 of FIG. 13, to transmit and receive a signal, information, and the like to and from the 5G network, the autonomous vehicle may perform an initial access procedure and a random access procedure in connection with the 5G network before operation S1 of FIG. 13 is performed.

Specifically, the autonomous vehicle may perform the initial access procedure in connection with the 5G network based on an SSB to acquire a DL synchronization and system information. In the initial access procedure, a BM process and a beam failure recovery process may be added. Also, a quasi-co location (QCL) relationship may be added in a process of receiving a signal from the 5G network by the autonomous vehicle.

The autonomous vehicle may perform the random access procedure in connection with the 5G network for acquisition of a UL synchronization and/or UL transmission. The 5G network may transmit a UL grant for scheduling transmission of specific information to the autonomous vehicle. The autonomous vehicle may transmit the specific information to the 5G network based on the UL grant. In addition, the 5G network may transmit a DL grant for scheduling transmission of a result of 5G processing for the specific information to the autonomous vehicle. The 5G network may transmit information or a signal associated with the remote control to the autonomous vehicle based on the DL grant.

A basic procedure of an application operation to which URLLC technology of the 5G communication and the method proposed in the present disclosure are applicable will be described as follows.

As described above, the autonomous vehicle may perform the initial access procedure and/or the random access procedure in connection with the 5G network, and then receive DownlinkPreemption IE from the 5G network. The autonomous vehicle may receive DownlinkPreemption IE a DCI format 2_1 including a preemption indication from the 5G network. The autonomous vehicle may not perform, expect, or assume reception of eMBB data on resources, for example, a PRB and/or an OFDM symbol indicated by the preemption indication. Thereafter, when specific information is to be transmitted, the autonomous vehicle may receive the UL grant from the 5G network.

A basic procedure of an application operation to which mMTC technology of the 5G communication and the method proposed in the present disclosure are applicable will be described as follows.

Among operations of FIG. 13, a part changed according to the application of the mMTC technology will be mainly described.

Referring to FIG. 13, in operation S1, the autonomous vehicle may receive a UL grant from the 5G network to transmit specific information to the 5G network. Here, the UL grant may include information on a number of repetitions for transmission of the specific information. The specific information may be repetitively transmitted based on the information on the number of repetitions. That is, the autonomous vehicle may transmit the specific information to the 5G network based on the UL grant. The repetitive transmission of the specific information may be performed through frequency hopping. For example, first transmission of the specific information may be performed on a first frequency resource and second transmission of the specific information may be performed on a second frequency resource. The specific information may be transmitted through a narrowband of a resource block 1RB or a resource block 6RB.

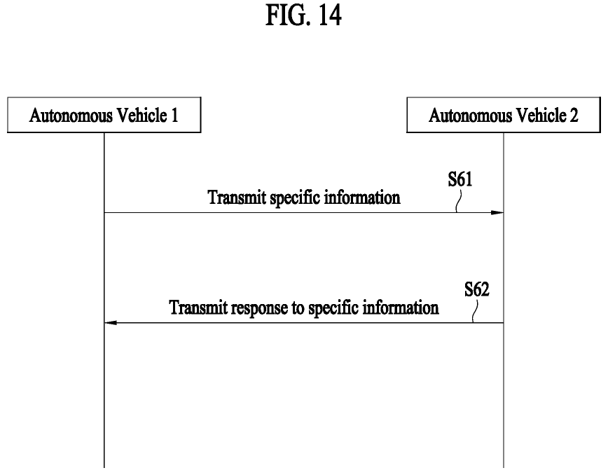

FIG. 14 illustrates an example of basic operations performed between a vehicle and another vehicle using 5G communication.

In operation S61, a first vehicle may transmit specific information to a second vehicle. In operation S62, the second vehicle may transmit a response to the specific information to the first vehicle.

A configuration of application operations between a vehicle and another vehicle may vary based on whether the 5G network is involved directly (sidelink communication transmitting mode 3) or indirectly (sidelink communication transmitting mode 4) with the specific information and resource allocation of a response to the specific information.

Application operations performed between a vehicle and another vehicle using the 5G communication will be described as follows.

First, how the 5G network is directly involved in resource allocation of signal transmission/reception between vehicles will be described.

The 5G network may transmit a DCI format 5A for scheduling of mode-3 transmission (PSCCH and/or PSSCH transmission) to the first vehicle. Here, a physical sidelink control channel (PSCCH) may be a 5G physical channel for scheduling transmission of specific information. Also, a physical sidelink shared channel (PSSCH) may be a 5G physical channel for transmitting the specific information. The first vehicle may transmit an SCI format 1 for scheduling transmission of specific information to the second vehicle on the PSCCH. Also, the first vehicle may transmit the specific information to the second vehicle on the PSSCH.

Next, how the 5G network is indirectly involved in resource allocation of signal transmission/reception between vehicles will be described.

The first vehicle may sense a resource for the mode-4 transmission in a first window. The first vehicle may select a resource for the mode-4 transmission in a second window based on a result of the sensing. Here, the first window may be a sensing window and the second window may be a selection window. The first vehicle may transmit the SCI format 1 for scheduling transmission of specific information to the second vehicle on the PSCCH based on the selected resource. Also, the first vehicle may transmit the specific information to the second vehicle on the PSSCH.

The autonomous vehicle performing at least one of V2V communication and V2X communication may transmit and receive information on a channel of the corresponding communication. For example, for the V2V communication and the V2X communication, channels for sidelinks corresponding to the communication methods may be allocated, so that the autonomous vehicle transmits and receives information on the corresponding channel to and from a server or another vehicle. Also, a shared channel for a sidelink may be allocated, so that a signal for at least one of the V2V communication and the V2X communication is transmitted and received on the corresponding channel. In order to perform at least one of the V2V communication and the V2X communication, the autonomous vehicle may acquire a separate identifier of the corresponding communication from at least one of a base station, a network, and another vehicle. The autonomous vehicle may perform the V2V communication and the V2X communication based on information on the acquired separate identifier.

Information transmitted through broadcasting may be transmitted on a separate channel for broadcasting. Node-to-node communication may be performed on a channel different from the channel for broadcasting. Also, information for controlling the autonomous vehicle may be transmitted on a channel for URLLC.

The devices in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer readable recording medium as computer readable codes or program commands which may be executed by the processor. Here, the computer readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer readable recording medium may be dispersed to computer systems connected by a network so that computer readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

What is claimed is:

1. A method of processing a vehicle to everything (V2X) message in a first device, the method comprising:
receiving a first V2X message from a second device;
identifying information included in the first V2X message;
generating a second V2X message using information acquired through a sensor and the first V2X message based on the identifying; and
transmitting the second V2X message to the second device.

2. The method of claim 1, wherein the identifying comprises:
identifying information to be changed or information to be added in the first V2X message and
the generating comprises:
generating, when the identified information is to be acquired through the sensor, the second V2X message by correcting the first V2X message based on the information acquired through the sensor.

3. The method of claim 1, wherein the identifying comprises:
identifying first information associated with at least one of a position, a velocity, and a size of the second device included in the first V2X message,
the generating comprises:
acquiring second information associated with at least one of a position, a velocity, and a size of the second device through the sensor; and
generating the second V2X message by changing the first information to the second information in the first V2X message.

4. The method of claim 3, wherein the second device identifies the second information of the second V2X message and updates information associated with at least one of a position, a velocity, and a size of the second device stored in a database.

5. The method of claim 1, wherein the receiving comprises:
receiving the first V2X message from the second device when the second device enters a predetermined region,
the identifying comprises:
identifying the first V2X message in which information on a route of the second device is absent, and
the generating comprises:
acquiring the information on the route of the second device through the sensor; and
generating the second V2X message by adding the acquired information on the route of the second device to the first V2X message.

6. The method of claim 1, further comprising:
receiving condition information associated with the first V2X message from the second device,
wherein the generating comprises:
generating, when the first device corresponds to the condition information, the second V2X message by correcting the first V2X message based on the information acquired through the sensor.

7. The method of claim 6, wherein the transmitting comprises:
transmitting the first V2X message to the second device when the first device does not correspond to the condition information.

8. The method of claim 6, wherein the condition information includes at least one of information on whether a device includes a predetermined sensor, information on a type of a device, information on a position of a device, and information on whether a device has an authority to correct a V2X message.

9. The method of claim 1, wherein the second device identifies information changed in the second V2X message in comparison to the first V2X message and transmits a third V2X message including the changed information to the first device.

10. The method of claim 1, further comprising:
transmitting the second V2X message to a third device receiving the first V2X message,
wherein the third device operates based on the second V2X message when at least a portion of the information included in the first V2X message is changed.

11. The method of claim 1, wherein the first V2X message includes information for identifying the first V2X message and
the second V2X message includes at least one of information for identifying the first V2X message and information for indicating information included in the second V2X message.

12. The method of claim 1, wherein the first V2X message is received on a first channel and
the second V2X message is transmitted on a second channel.

13. The method of claim 1, wherein each of the first device and the second device is at least one of a vehicle, a user terminal, an infrastructure, and a server.

14. A method of processing a vehicle to everything (V2X) message, the method comprising:
receiving, by a first device, a first V2X message from a second device;
identifying, by the first device, information included in the first V2X message;
generating, by the first device, a second V2X message using information acquired through a sensor and the first V2X message based on the identifying;
transmitting, by the first device, the second V2X message to the second device; and
operating the second device based on the second V2X message.

15. The method of claim 14, wherein the identifying comprises:
identifying information to be changed or information to be added in the first V2X message and
the generating comprises:
generating, when the identified information is to be acquired through the sensor, the second V2X message by correcting the first V2X message based on the information acquired through the sensor.

16. The method of claim 14, wherein the operating comprises:
identifying information changed in the second V2X message in comparison to the first V2X message and updating a database based on the changed information.

17. The method of claim 16, wherein the operating comprises:
transmitting a third V2X message including the changed information to the first device.

18. The method of claim 14, further comprising:
receiving, by a third device, the first V2X message from the second device;
receiving, by the third device, the second V2X message from the first device; and
operating the third device based on the second V2X message when at least a portion of the information included in the first V2X message is changed in the second V2X message.

19. A non-transitory computer-readable storage medium storing programs to execute the method of claim 1.

20. A device for processing a vehicle to everything (V2X) message, the device comprising:
a communicator; and
a controller configured to receive a first V2X message from another device through the communicator, identify information included in the first V2X message, generate a second V2X message using information acquired through a sensor and the first V2X message based on the identifying, and transmit the second V2X message to the other device through the communicator.
